(19) United States
(12) Patent Application Publication
(10) Pub. No.: US 2004/0222655 A1
(43) Pub. Date: Nov. 11, 2004

(54) Cylindrical storage device and lining element comprising the storage device

(75) Inventors: Claude Magniez, Andeville (FR); Sebastien Trillat, Poissy (FR)

Correspondence Address: YOUNG & THOMPSON, 745 SOUTH 23RD STREET 2ND FLOOR, ARLINGTON, VA, 22202

(73) Assignee: FAURECIA INTERIEUR INDUSTRIE, NANTERRE (FR)

(21) Appl. No.: 10/839,677

(22) Filed: May 6, 2004

(30) Foreign Application Priority Data
May 7, 2003 (FR) 03 05587

(51) Int. Cl. B60R 7/04

(52) U.S. Cl. 296/37.13

(57) ABSTRACT

Storage device (2) includes a receptacle (12), a concealing wall (10) and articulation element (18). The receptacle (12) has a cavity (14) delimited by a cylindrical shell of substantially circular cross-section extending along a substantially vertical axis (20), the shell having a radial opening (16) for access to the cavity. The concealing wall (10) has the shape of a portion of a cylinder extending substantially along the axis. The articulation element (18) moves the concealing wall (10) and the receptacle (12) relative to one another by rotation about the axis between a closed position in which the radial opening is concealed by the concealing wall and an open position in which the radial opening is substantially remote from the wall.

### BACKGROUND OF THE INVENTION

The invention relates to a storage device particularly for a motor vehicle.

Devices of this-type comprise a receptacle having a cavity for receiving various objects to which access can be obtained through an opening. They are arranged in particular in the dashboard or the door linings and are known as cubby-holes or glove compartments.

A device is currently known, the receptacle of which is movable between a closed position in which it is concealed inside a housing and an open position in which it is out of the housing thus affording access to the contents of the receptacle through the opening. The transition from the closed position to the open position is performed by displacement (generally by tilting) towards the interior of the passenger compartment so that, in the open position, the receptacle projects into the passenger compartment. As a result, when it is in the open position, a device of this type risks constituting an inconvenience to the occupant of the vehicle unless the volume of the receptacle is reduced.

EP-A-0 721 857 describes a device which overcomes this disadvantage. This device comprises a cover which pivots relative to the receptacle about a substantially horizontal axis between an active position in which it closes the opening and a concealed position affording access to the objects.

However, when the device changes from the active position to the concealed position and vice versa, the objects are transferred from the receptacle to the cover and vice versa. The objects thus risk being mixed up which in practice limits the scope for the use of such a storage device.

### SUMMARY OF THE INVENTION

To overcome the disadvantages discussed above with reference to the prior-art devices described, according to the invention, the storage device comprises:

a receptacle having a cavity delimited by a cylindrical shell of substantially circular cross-section extending along a substantially vertical axis, said shell having a radial opening for access to the cavity,

a concealing wall having the shape of a portion of a cylinder extending substantially along said axis,

articulation means for moving said concealing wall and said receptacle relative to one another by rotation about said axis between a closed position in which said radial opening is concealed by said concealing wall and an open position in which said radial opening is substantially remote from said wall concealing.

Thus the objects do not risk being mixed up or damaged and the ratio between the volume of the cavity and the space required by the storage device is high (about 80%) both in the closed position and in the open position.

To improve the retention of the objects in the receptacle, in particular in the open position, according to the invention, the device is such that:

the receptacle extends along the axis between a lower end and an upper end,

the radial opening is spaced from the lower end so that the receptacle has, in the vicinity of the lower end, a rim extending below said radial opening.

The invention also relates to a lining element equipped with a storage device. According to the invention, the lining element has the following characteristics:

said lining element comprises a support which incorporates the concealing wall and is intended to be fixed to the structure of the vehicle,

the concealing wall defines a housing in which said receptacle is disposed,

said receptacle is mounted for pivoting about the axis on said support by means of said articulation means.

The incorporation of the storage device in the lining element is thus quite easy so as to give rise merely to a moderate additional cost in order to equip the lining element with the storage device.

### BRIEF DESCRIPTION OF THE DRAWINGS

The invention will become clearer from the following description which is given with reference to the appended drawings, in which:

FIG. 1 shows a lining element comprising a storage device according to the invention in the open position,

FIG. 2 shows the storage device of FIG. 1 in median section,

FIG. 3 shows the storage device in the closed position in median section,

FIG. 4 shows a second storage device according to the invention in the open position,

FIG. 5 shows the second storage device in the closed position,

FIG. 6 is a section taken on the line VI-VI in FIG. 5.

### DETAILED DESCRIPTION OF THE PREFERRED EMBODIMENT

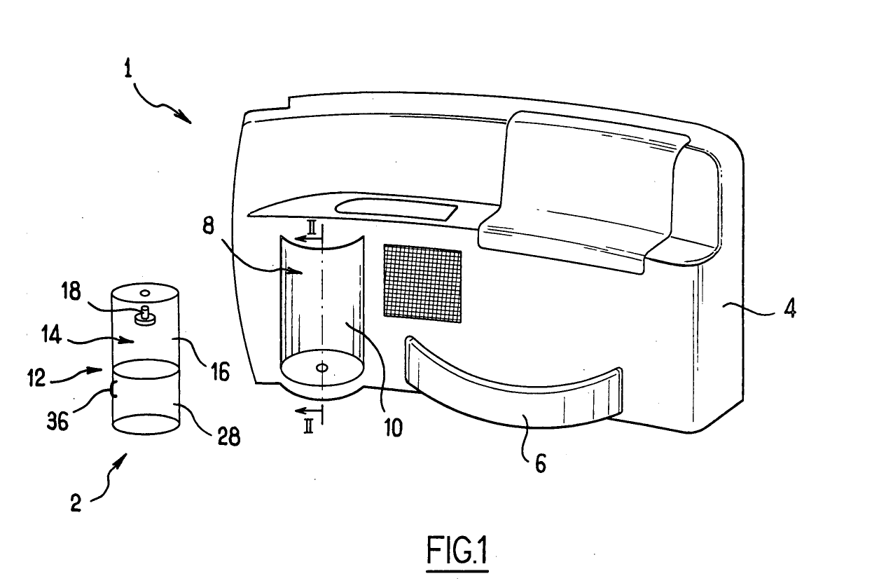

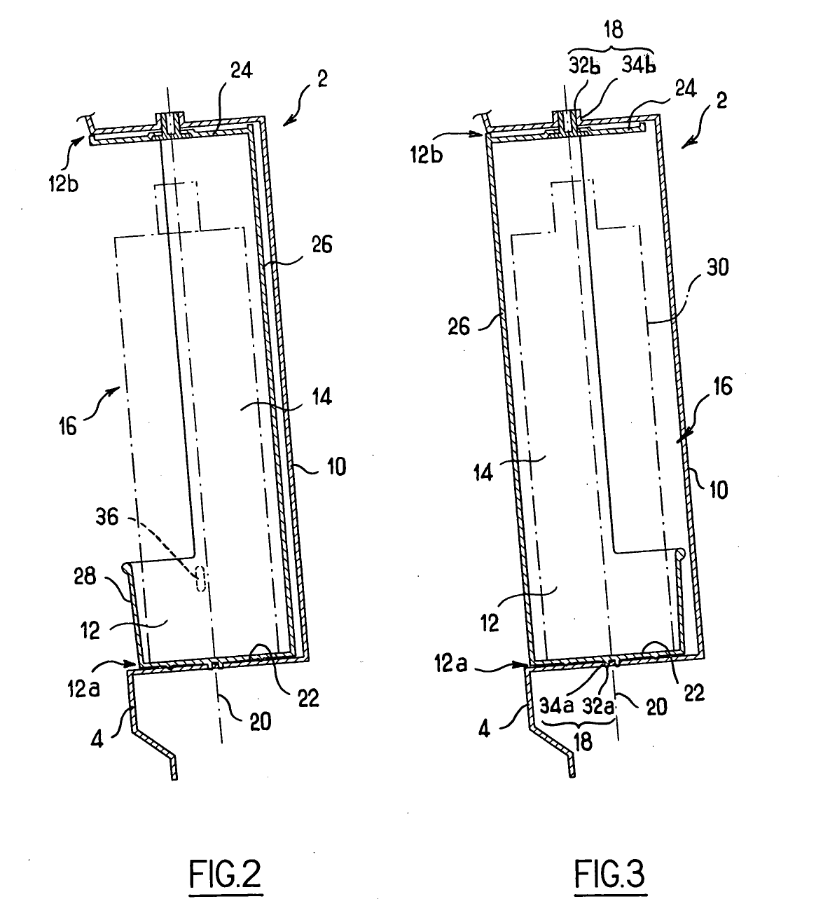

FIGS. 1 to 3 show an internal door-lining element 1 comprising, in particular, a panel to be fixed to the door of a vehicle and forming a support for an open storage compartment 6 and for a concealable storage device 2 according to the invention.

Said storage device 2 comprises a receptacle 12 and means 18 for connection between the receptacle 12 and the door panel 4.

The receptacle 12 extends along a substantially vertical axis 20 between a lower end 12a and an upper end 12b. The receptacle 12 is substantially cylindrical with a circular cross-section and comprises a cavity 14 delimited by a base wall 22 and a top wall 24 which are in the form of solid disks, connected to one another by a tubular wall 26.

Said tubular wall 26 has a radial opening 16 extending substantially through 180 degrees and substantially along four fifths of the height of the receptacle 12, starting from the top wall 24. A rim 28 for retaining objects disposed inside the cavity 14 extends below the radial opening 16 as far as the lower end 12a. A bottle 30 has been shown in chain line here as contents of the cavity 14.

The connection means 18 are constituted by pins 32a, 32b which are connected to the base wall 22 and to the top wall 24, respectively, and are inserted in complementary holes 34a, 34b provided in the door panel 4. They hold the receptacle 12 inside a hollow housing 8 provided in the door panel 4. Said housing 4 has a shape complementary with that of the receptacle 12 and is delimited by a semicylindrical concealing wall 10 of circular cross-section extending along the axis 20.

Said connection means 18 guide the receptacle 12 for rotation about the axis 20 between an open position in which the radial opening 16 is remote from the concealing wall 10 and a closed position in which the radial opening is disposed facing the concealing wall 10.

A handle 36 facilitates gripping of the receptacle in order to move it from one position towards the other.

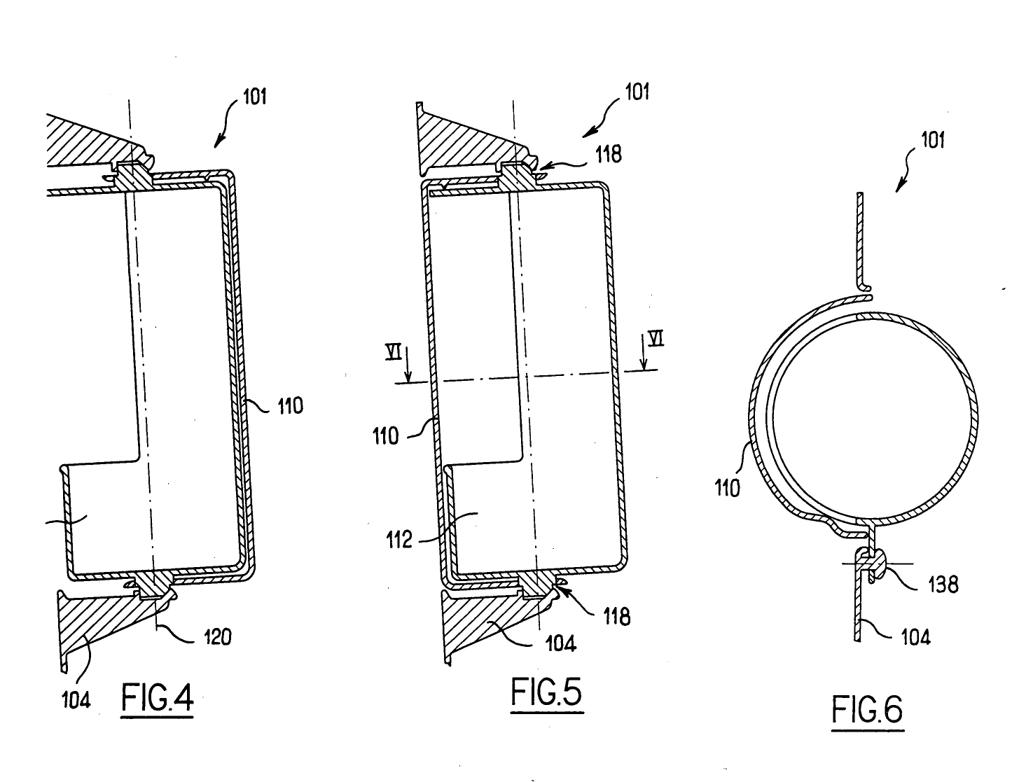

FIGS. 4 to 6 show a lining element 101 which is distinguished from the lining element shown in FIGS. 1 to 3 substantially in that the receptacle 112 is fixed to the door panel 104 (for example, by snap-rivets 138) and the semicylindrical concealing wall 110 is mounted so as to be rotatable about the axis 120 relative to the door panel 104 by articulation means 118.

Elements corresponding to those of FIGS. 1 to 3 have reference numerals increased by 100.

We claim:

1. Storage device particularly for a motor vehicle, comprising:
a receptacle having a cavity delimited by a cylindrical shell of substantially circular cross-section extending along a substantially vertical axis, said shell having a radial opening for access to the cavity,
a concealing wall having the shape of a portion of a cylinder extending substantially along said axis,
articulation means for moving said concealing wall and said receptacle relative to one another by rotation about said axis between a closed position in which said radial opening is concealed by said concealing wall and an open position in which said radial opening is substantially remote from said concealing wall.

2. Device according to claim 1, wherein:
the receptacle extends along the axis between a lower end and an upper end,
the radial opening is spaced from the lower end so that the receptacle has, in the vicinity of the lower end, a rim extending below said radial opening.

3. Lining element for a motor vehicle equipped with a device according to claim 1, wherein:
said lining element comprises a support which incorporates the concealing wall and is intended to be fixed to the structure of the vehicle,
the concealing wall defines a housing in which said receptacle is disposed,
said receptacle is mounted for pivoting about the axis on said support by means of said articulation means.
